(19) United States
(12) Patent Application Publication
(10) Pub. No.: US 2024/0053758 A1
(43) Pub. Date: Feb. 15, 2024

(54) SELF-MOVING ROBOT AND METHOD OF AUTOMATICALLY DETERMINING AN ACCESSIBLE REGION THEREOF

(71) Applicant: KINPO ELECTRONICS, INC., New Taipei City (TW)

(72) Inventors: Huan-Chen LING, NEW TAIPEI CITY (TW); Tien-Ping LIU, NEW TAIPEI CITY (TW); Chung-Yao TSAI, NEW TAIPEI CITY (TW)

(21) Appl. No.: 18/078,741

(22) Filed: Dec. 9, 2022

(30) Foreign Application Priority Data
Aug. 9, 2022 (TW) 111129818

(51) Int. Cl. G05D 1/02

(52) U.S. Cl. CPC G05D 1/0214; G05D 1/0274; G05D 1/0257; G05D 1/024; G05D 1/0255; G05D 1/0248; G05D 2201/0203

(57) ABSTRACT

A self-moving robot and a method of automatically determining an accessible region are provided. The self-moving robot performs a setting process of 2D obstacles to generate a goal map based on an exploration map, performs a setting process of 3D obstacles on the goal map to update the accessible region of the goal map when a 3D obstacle is detected, performs an avoidance action, and, moves within the accessible region of the goal map. The disclosure prevents the self-moving robot from colliding with obstacles or being trapped.

### BACKGROUND OF THE INVENTION

### Technical Field

The technical field relates to a self-moving robot, and specifically relates to a self-moving robot capable of automatically determining an accessible region and a method of automatically determining the accessible region.

### Description of Related Art

There are different types of self-moving robots proposed in the market. A current self-moving robot may automatically build a map of a surrounding environment and move within the surrounding environment based on the map build by the self-moving robot.

To build the map more quickly, a self-moving robot being applied with a 2D radar is provided to the market. This type of self-moving robot usually has an extremely low body-height (e.g., the self-moving robot may be a sweeping robot). The robot performs 2D scanning to the environment by using the 2D radar to build a 2D map (such as a planimetric map); however, the 2D map built through using above approach may only provide 2D information about the obstacles. In other words, these type of self-moving robot moves and operates close to the ground, so the 2D information about the obstacles only includes the information of the obstacles that are existing close to the ground. In this scenario, the 2D map built by the self-moving robot lacks 3D information. When the body-height of the self-moving robot increases, it is easier for the self-moving to collide with the obstacles.

To prevent the robot from colliding with the obstacles, another type of self-moving robot (which is a robot having a higher body-height, e.g., a patrol robot or a transport robot) is provided. This type of robot may move according to certain routes that are evaluated and set by human, or the robot may be guided by human to move along an appropriate route and then record the route being guided.

To the robots having higher body-height, a problem to the current approach of automatically determining an accessible region should be solved. In other words, a quick, precise, real-time, and effective approach should be provided.

### SUMMARY OF THE INVENTION

The disclosure is directed to a self-moving robot capable of automatically determining an accessible region and a method of automatically determining the accessible region, which may quickly build a map for movement that includes a 2D map for the function of 3D avoidance.

In one of the exemplary embodiments, a method of automatically determining an accessible region being applied by a self-moving robot having a 2D detecting device and a 3D avoidance device is provided and includes following steps: a) obtaining an exploration map; b) performing a 2D obstacle setting process in accordance with the exploration map to generate a goal map, wherein the goal map is marked with an accessible region that excludes a 2D obstacle region; c) before a moving procedure, sensing a 3D obstacle through the 3D avoidance device, performing a 3D obstacle setting process to the goal map to set a 3D obstacle region corresponding to the 3D obstacle and update the accessible region to exclude the 3D obstacle region, and controlling the self-moving robot to perform an avoidance action; and d) controlling the self-moving robot to move within the accessible region of the goal map.

In one of the exemplary embodiments, a self-moving robot capable of automatically determining an accessible region is provided and includes a driving device, a 2D detecting device, a 3D avoidance device, a storage, and a processing device electrically connected with the driving device, the 2D detecting device, the 3D avoidance device, and the storage. The driving device is used to move the self-moving robot; the 2D detecting device is used to perform a 2D scanning to an environment; the 3D avoidance device is used to detect a 3D obstacle in the environment; the storage is used to store an exploration map; the processing device performs a 2D obstacle setting process based on the exploration map to generate a goal map, wherein the goal map is marked with an accessible region excluding a 2D obstacle region; the processing device controls the self-moving robot to move within the accessible region, wherein, the processing device is configured to, before a moving procedure, detect the 3D obstacle and perform a 3D obstacle setting process to the goal map to set a 3D obstacle region corresponding to the 3D obstacle being detected and update the accessible region to exclude the 3D obstacle region, and control the self-moving robot to perform an avoidance action.

The present disclosure may prevent a self-moving robot from colliding with obstacles or being trapped.

### DESCRIPTION OF THE DRAWINGS

FIG. 1 is a schematic diagram of a self-moving robot of an embodiment according to the present disclosure.

FIG. 2 is a schematic diagram of a processing device of an embodiment according to the present disclosure.

FIG. 3 is a flowchart of an automatic determining method of an embodiment according to the present disclosure.

FIG. 4 is a flowchart of an exploration mode of an embodiment according to the present disclosure.

FIG. 5 is a flowchart of a 2D obstacle setting process of an embodiment according to the present disclosure.

FIG. 6 is a flowchart of an operation mode of an embodiment according to the present disclosure.

FIG. 7 is a flowchart of a 3D obstacle setting process of an embodiment according to the present disclosure.

FIG. 8 is a schematic diagram showing an exploration map of an embodiment according to the present disclosure.

FIG. 9 is a schematic diagram showing a goal map of an embodiment according to the present disclosure.

FIG. 10 is a schematic diagram showing multiple layers of an exploration map of an embodiment according to the present disclosure.

FIG. 11 is a schematic diagram showing multiple layers of a goal map of an embodiment according to the present disclosure.

FIG. 12 is an environment planimetric map of an embodiment according to the present disclosure.

FIG. 13 is a schematic diagram of an exploration map built based on the environment of FIG. 12.

FIG. 14 is a schematic diagram of a goal map built based on the environment of FIG. 12.

FIG. 15 is a schematic diagram of performing an operation under the environment of FIG. 12.

FIG. 16 is a schematic diagram of completing the operation under the environment of FIG. 12.

FIG. 17 is a schematic diagram showing an environment of an embodiment according to the present disclosure.

FIG. 18 is a schematic diagram showing a goal map built based on FIG. 17.

FIG. 19 is a schematic diagram showing a worked region of an embodiment according to the present disclosure.

### DETAILED DESCRIPTION OF THE INVENTION

In cooperation with the attached drawings, the technical contents and detailed description of the present invention are described hereinafter according to multiple embodiments, being not used to limit its executing scope. Any equivalent variation and modification made according to appended claims is all covered by the claims claimed by the present invention.

The present disclosure discloses a self-moving robot capable of automatically determining an accessible region and a method of automatically determining the accessible region (referred to as the robot and the method hereinafter). The method uses a 2D map of the environment (which is an exploration map) built by a 2D detection control module, and also uses another 2D map (which is a goal map).

The exploration map is used for locating and track recording. In particular, the exploration map is used to indicate a planimetric map of the environment where the robot is located. When the robot moves and explores in the environment under an exploration mode or an operation mode, it may use a specific module (such as a positioning module 304 described in the following) to continuously locate the current position and generate consecutive position information, form a moving track of the robot in accordance with the consecutive position information, and record the moving track in the exploration map.

The goal map includes the position information of 2D obstacle(s) obtained through performing 2D scanning and the position information of 3D obstacle(s) created through performing 3D sensing, so the goal map may be used to correctly indicate an accessible region that the robot won't collide with the obstacles.

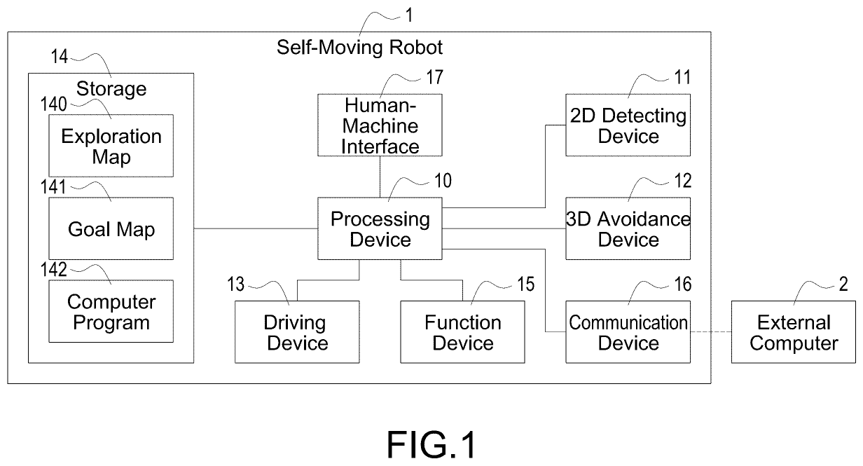

Please refer to FIG. 1, which is a schematic diagram of a self-moving robot of an embodiment according to the present disclosure. The self-moving robot 1 (referred to as the robot 1 hereinafter) of the present disclosure includes a 2D detecting device 11, a 3D avoidance device 12, a driving device 13, a storage 14, and a processing device 10 electrically connected with the above devices.

The 2D detecting device 11 may be a laser ranging sensor, a LiDAR, or other types of 2D radar. The 2D detecting device 11 is used to perform 2D scanning to the environment from its arrangement position to obtain 2D information of the environment. For example, the 2D information of the environment detected by the 2D detecting device 11 may be the distance between the robot 1 and other objects located in the plane.

The 3D avoidance device 12 may be an image capturing device (may be combined with computer vision), a depth camera, an ultrasonic sensor, or other avoidance sensor, and is used to sense whether a 3D obstacle is close to the arrangement position of the 3D avoidance device 12. For example, the 3D avoidance device 12 may be triggered when a distance between the robot 1 and a 3D obstacle located in the 3D space is smaller than a default distance.

In one embodiment, the arrangement position of the 3D avoidance device 12 is higher than the arrangement position of the 2D detecting device 11, so that the 3D avoidance device 12 may perform obstacle detection within a height range that the 2D detecting device 11 is unable to detect. In one embodiment, the arrangement position of the 3D avoidance device 12 should be ensured that the height range of the detection function of the 3D avoidance device 12 is equal to or higher than the highest height of the robot 1 itself. In one embodiment, the number of the 3D avoidance device 12 is plural, the arrangement position of each of the 3D avoidance devices 12 is different, and the processing speed and density of each 3D avoidance device 12 is different as well. For example, the processing speed and density of one of the 3D avoidance devices 12 arranged at a middle-high position is higher than that of another 3D avoidance device 12 arranged at a highest position.

The driving device 13 may include transportation elements such as motors, gear sets, and tires, etc., and is used to assist the robot 1 to move to an indicated position (i.e., a destination).

The storage 14 may include a cache memory, a FLASH memory, a RAM, an EEPRAM, a ROM, other storing components, or a combination of any of the above-mentioned memories, and is used to store data and information of the robot 1. For example, the storage 14 may be used to store an exploration map 140 and a goal map 141 as described in the following.

It should be mentioned that in the present disclosure, the exploration map 140 is a planimetric map used to indicate the surrounding environment and optionally indicate the moving track of the robot 1, and the goal map 141 is used to mark the accessible region(s) that the robot 1 won't collide with the obstacles in the environment. In one embodiment, the robot 1 includes a function device 15 that is electrically connected with the processing device 10, and the robot 1 executes a specific functional action by using the function device 15.

For example, if the function device 15 is one of a germicidal lamp, a disinfectant sprinkler, an environment sensor (such as a temperature sensor, a humidity sensor, or a carbon monoxide sensor, etc.), or a patrol device (such as a surveillance camera or a thermal imager), the functional action may be opening the germicidal lamp, spraying the disinfectant, obtaining environment status (such as the temperature, the humidity, or the carbon monoxide concentration, etc.), or detecting for intrusion (such as determining whether an intrusion occurs by referring to RGB images, IR images, or thermal images).

For another example, if the function device 15 is an image capturing device or a sterilizing device, the functional action may be a monitoring action or a sterilizing action. The monitoring action may be capturing the image of the environment through the image capturing device, executing abnormal detection to the captured images, and sending out an alarm to an external computer 2 through a communication device 16 when any abnormal status is detected. The sterilizing action may be activating the sterilizing device to perform sterilization to the environment.

In one embodiment, the robot 1 may include a communication device 16 electrically connected with the processing device 10. The communication device 16 is used for the robot 1 to connect with an external computer 2 for communication. The communication device 16 may be, for example but not limited to, an IR communication module, a Wi-Fi™ module, a cellular network module, a Bluetooth™ module, or a Zigbee™ module, etc. The external computer 2 may be, for example but not limited to, a remote computer such as a remote control, a tablet, or a smart phone, etc., a cloud server, or a network database, etc.

In one embodiment, the robot 1 may include a human-machine interface (HMI) 17 electrically connected with the processing device 10, and the HMI 17 is used to provide information and interact with the user. The HMI 17 may be, for example but not limited to, any combination of I/O devices including a touch screen, buttons, a display, an indicator, and a buzzer, etc.

In one embodiment, the robot 1 may include a battery (not shown), and the battery is used to provide essential power for the robot 1 to operate.

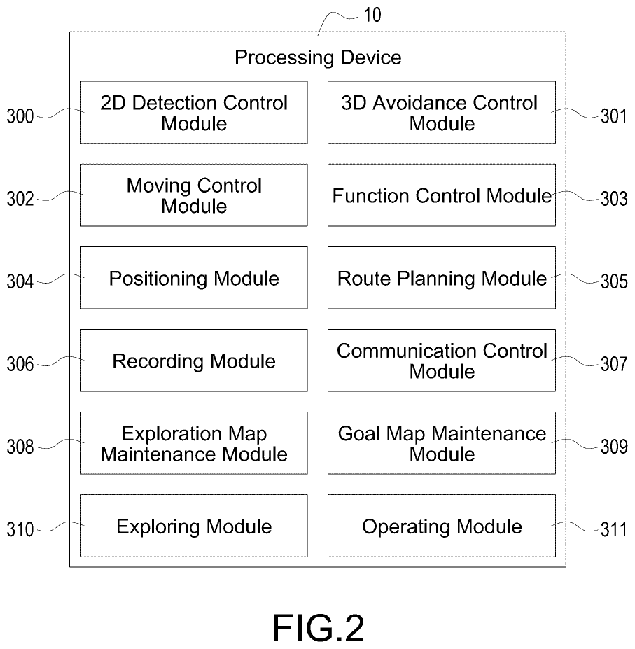

Please refer to FIG. 2, which is a schematic diagram of a processing device of an embodiment according to the present disclosure. In the present disclosure, the processing device 10 of the robot 1 may include multiple modules 300-311 used to implement different function.

A 2D detection control module 300 is set to control the 2D detecting device 11 to scan the surrounding environment to obtain a 2D scanning result. The 2D scanning result may include environmental information that is substantially close to the ground.

A 3D avoidance control module 301 is set to control the 3D avoidance device 12 to detect a 3D obstacle with a height beyond the scanning height of the 2D detecting device 11, and the 3D avoidance control module 301 further identifies the position of the 3D obstacle being detected.

A moving control module 303 is set to control the driving device 13 to move the robot 1 to a designated destination.

A function control module 303 is set to control the function device 15 to execute a preset functional action.

A positioning module 304 is set to compute the current position of the robot 1 based the exploration map 140. For example, the positioning module 304 may be used to compute the current position of the robot 1 through indoor positioning technology or the moving track of the robot 1.

A route planning module 305 is set to plan a route from the current position to a designated position (such as a position designated by the user or a position of a charging station, etc.), or a route from the current position to roam within the environment (i.e., around all the positions of the accessible region) and then move back to a standby position (such as a position designated by the user or a position of a charging station, etc.).

A recording module 306 is set to control the data access of the storage 14 and may automatically store map data.

A communication control module 307 is set to control the communication device 16 to communicate with the external computer 2 through correct communication protocol.

An exploration map maintenance module 308 is set to maintain the exploration map 140 based on the positioning result. For example, under an exploration mode, the exploration map maintenance module 308 may update explored regions (such as adding or changing a 2D obstacle region) and un-explored regions (such as changing a part of the un-explored regions into the explored regions) based on the current position and the 2D scanning result.

In particular, the exploration map maintenance module 308 transforms a region that the robot 1 has passed by under the exploration mode into the explored region, so as to build or update the exploration map 140. The exploration map 140 may be a planimetric map indicating the environment that is built correspondingly by the 2D detecting device 11 through performing 2D scanning.

It should be mentioned that the 2D obstacle region in the present disclosure indicates a region in the environment where a 2D obstacle exists, wherein the 2D obstacle is included in a 2D scanning result generated by the robot 1 after the robot 1 performs the 2D scanning to the environment. Due to the existence of the 2D obstacle, the robot 1 may not safely move within this region. The present disclosure sets the region having the 2D obstacle as the 2D obstacle region, so that the robot 1 may exclude this region from the accessible regions which are regarded as safe regions.

In one embodiment, the processing device 10 may update, under the operation mode, accessed region(s) and not-yet-accessed region(s) of the exploration map 140 for this operation based on the current position of the robot 1, and record the moving route of the robot 1 for this operation.

A goal map maintenance module 309 is set to generate a goal map 141 and maintain the goal map 141 based on the positioning result. For example, the goal map maintenance module 309 may set and update an accessible region in accordance with newest 2D obstacle region (exploration mode) and 3D obstacle region (operation mode). Also, the goal map maintenance module 309 may update (to enlarge in some cases) the range of a worked region in the goal map 141 based on the position of executing the functional action.

An exploring module 310 is set to enter the exploration mode to control the robot 1 to explore the environment. For example, the robot 1 may be controlled by the exploring module 310 to explore an un-explored region, or to re-explore an explored region and update the region data of the environment.

An operating module 311 is set to enter the operation mode to control the robot 1 to execute operating tasks in the environment. For example, the robot 1 may be controlled by the operating module 311 to perform sterilization, patrol, or measurement, etc.

It should be mentioned that the aforementioned modules 300-311 are connected with each other, wherein the modules 300-311 may connect with each other through electrical connection or information connection. In one embodiment, the modules 300-311 are hardware modules, such as electronic circuit modules, integrated circuit modules, or system on chips, etc. In another embodiment, the modules 300-311 are software modules or combinations of hardware modules and software modules, but not limited thereto.

If the modules 300-311 are software modules (e.g., the modules are implemented by firmware, operating system, or application program), the storage 14 of the robot 1 may include a non-transitory computer readable media, the non-transitory computer readable media records a computer program 142, and the computer program 142 records computer executable program codes. After the processing device 10 executes the computer executable program codes, the control functions of each of the modules 300-311 may be implemented through the computer executable program codes.

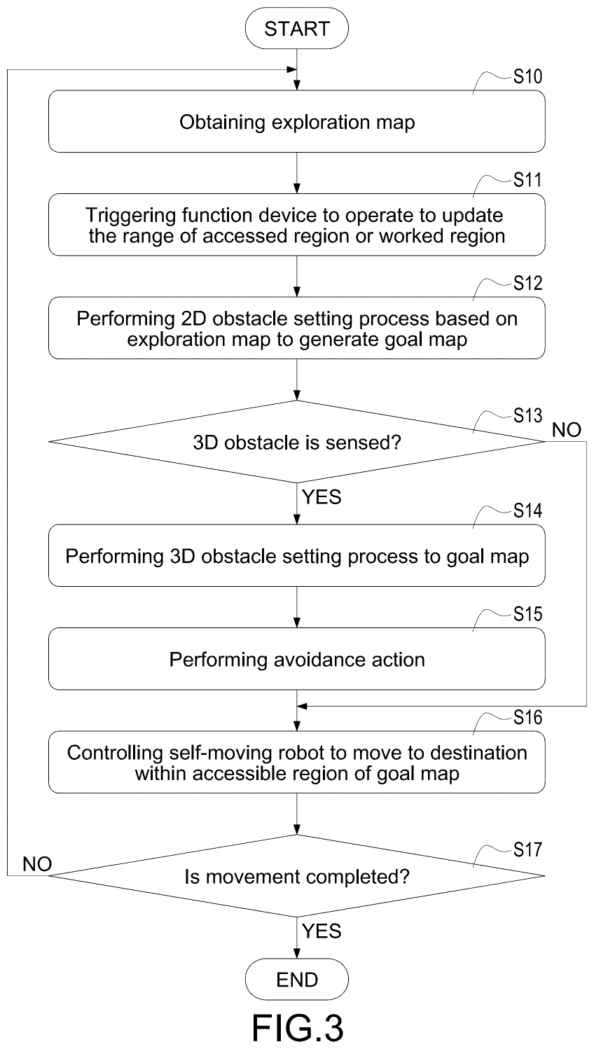

Please refer to FIG. 3, which is a flowchart of an automatic determining method of an embodiment according to the present disclosure. The automatic determining method of each embodiment of the present disclosure may be implemented by the robot disclosed in any embodiment of the present disclosure, and the following description is disclosed based on the robot 1 depicted in FIG. 1 and FIG. 2.

In the embodiment, the processing device 10 may enter the operation mode through the operating module 311, so that the robot 1 may move to different positions for operation under the operation mode (i.e., to execute steps S10 to S16).

Step S10: the processing device 10 obtains the exploration map 140 through the exploration map maintenance module 308.

In one embodiment, the processing device 10 receives the exploration map 140 through the communication device 16 from the external computer 2 (such as a user computer, a management server in the environment, or a map database) or reads a pre-stored exploration map 140 from the storage 14 (e.g., the exploration map 140 generated by the robot 1 through exploring within the environment under the exploration mode). The detailed approach for the exploration mode will be discussed in the following.

Step S11: The processing device 10 triggers the function device 15 to execute the functional action, and the processing device 10 may, based on an effective operation range of the function device 15, update the accessed region with respect to the robot 1 in the exploration map 140 and/or the range of the worked region with respect to the robot 1 in the goal map 141. Therefore, the processing device 10 may regulate the accessible region of the robot 1.

It should be mentioned that when the robot 1 executes the functional action through the function device 15 (such as the monitoring action or the sterilizing action mentioned above), it may simultaneously trigger the driving device 13 to move the robot 1. Therefore, the robot 1 may implement the executed functional action at a certain location, within a designated region, or along a pre-determined route.

Step S12: The processing device 10 may perform 2D obstacle setting process through the goal map maintenance module 309 based on the exploration map 140 that is updated after the functional action is executed, so as to generate the goal map 141. The goal map 141 may mark an accessible region of the robot 1, and the accessible region covers the region that excludes the 2D obstacle region(s), wherein the information related to the 2D obstacle region(s) may be obtained from the exploration map 140. When the robot 1 moves within the accessible region, it won't collie with any 2D obstacle.

Step S13: Before moving the robot 1 (i.e., during the millisecond after the processing device 10 compute a target position coordinate that the robot 1 needs to go based on the accessible region recorded in the goal map 141 and before the robot 1 real moves), the processing device 10 may control the 3D avoidance device 12 through the 3D avoidance control module 301 to sense the 3D obstacle in the environment, wherein the 3D obstacle is located in a position or a range in the environment that the 2D detecting device 11 cannot correctly detect (i.e., a blind spot of the 2D detecting device 11). Therefore, in any time point while moving the robot 1, the processing device 10 may continuously detect whether the robot 1 is approaching any 3D obstacle through the 3D avoidance device 12, so as to continuously determine whether a collision may occur.

When any 3D obstacle is detected, the step S14 is executed; otherwise, the robot 1 is controlled to keep moving and the step S16 is executed. It should be mentioned that the processing device 10 may continuously compute next target position coordinate that the robot 1 needs to go (including a final destination), and continuously sense the 3D obstacle during computing and moving.

Step S14: The processing device 10 may perform 3D obstacle setting process to the goal map 141 through the goal map maintenance module 309, so as to set a 3D obstacle region corresponding to the 3D obstacle in the goal map 141 and update the accessible region. Therefore, the 3D obstacle region being set in the goal map 141 may be excluded from the accessible region. When the robot 1 moves within the accessible region, it may actively avoid moving to a region where the 3D obstacle exists without using the 3D obstacle device 12, and the avoidance rate may be increased.

Step S15: The processing device 10 may control the driving device 13 through the 3D avoidance control module 301 and the moving control module 302 for the robot 1 to perform the avoidance action. In a first embodiment, the processing device 10 may control the robot 1 to stop moving. In a second embodiment, the processing device 10 may re-compute a next moving target position within the accessible region that the robot 1 may avoid the 3D obstacle and then control the robot 1 to move to the next moving target point. In a third embodiment, the processing device 10 may control the robot 1 to move toward a direction that is away from the 3D obstacle.

Step S16: If no 3D obstacle is sensed or the avoidance action with respect to a 3D obstacle has executed, the processing device 10 may control the driving device 13 through the moving control module 302 to move the robot 1 to the next position coordinate (including the final destination) based on the accessible region indicated by the goal map 141.

Step S17: The processing device 10 determines whether the movement of the robot 1 is completed through the operating module 311. For example, the processing device 10 determines, through the operating module 311, whether the robot 1 has completely explored the preset route, has arrived a destination, or has left the operation mode. It should be mentioned that one or more movements may be performed when the function device 15 executes the functional action. In the step S17, the processing device 10 may determine whether one movement (e.g., the movement for the robot 1 to move to the next position coordinate) is completed or not, or whether all the movements requested by the functional action are completed (e.g., the robot 1 arrives the destination), but not limited thereto.

If the movement is not yet completed, the steps S10 to S16 are executed again; otherwise, the automatic determining method of the present disclosure is ended.

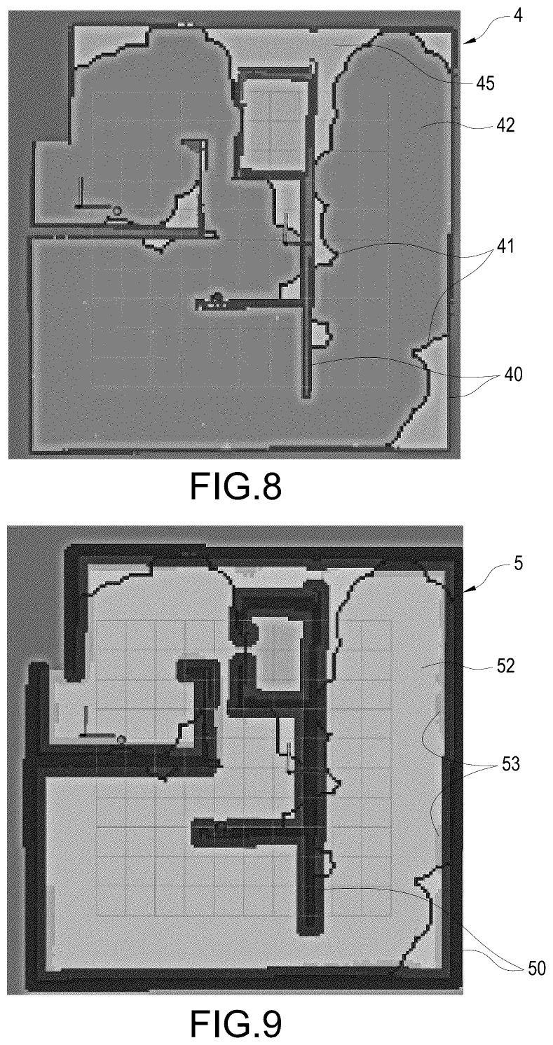

Please refer to FIG. 8 and FIG. 9, wherein FIG. 8 is a schematic diagram showing an exploration map of an embodiment according to the present disclosure and FIG. 9 is a schematic diagram showing a goal map of an embodiment according to the present disclosure.

As disclosed in FIG. 8, the exploration map 4 may include a 2D obstacle region 40 and an explored region 42, and a boundary 41 between the explored region 42 and an un-explored region 45 is indicated in the exploration map 4.

The 2D obstacle region 40 may include 2D obstacles detected by the 2D detecting device 11, such as a wall, table legs, a door, or chair legs, etc.

The explored region 42 may be the position that the robot 1 has passed by under the exploration mode, and the explored region 42 may be appropriately expanded based on the size of the robot 1 (detailed described in the following).

It should be mentioned that the 2D detecting device 11 has a detection range with a certain length and a certain width (e.g., 10 m of height and 5 m of width) based on its specification, so that the 2D obstacle region 40 being scanned by the 2D detecting device 11 may not be within the explored region 42. In other words, the un-explored region 45 may exist between the 2D obstacle region 40 and the explored region 42.

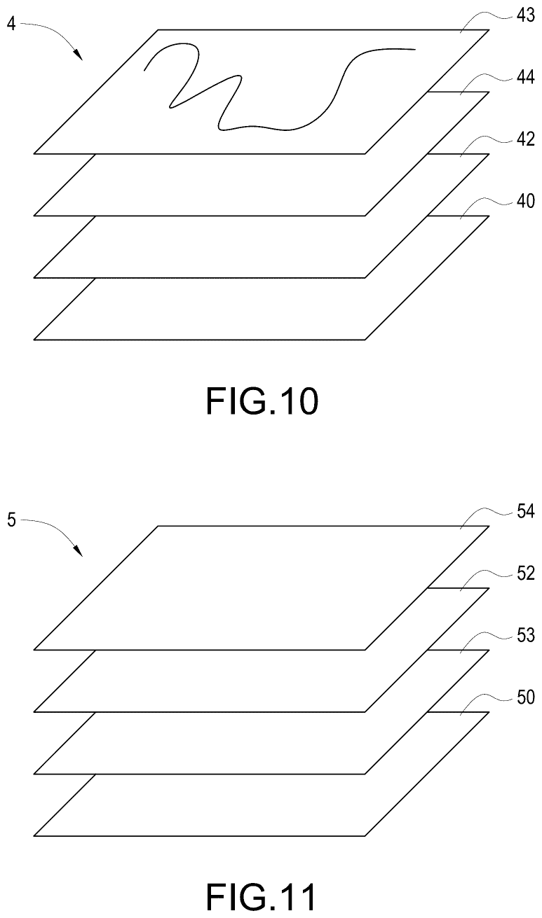

Besides, every time when the robot 1 enters the operation mode, the explored region 42 may be optionally hidden or not be used. For substitution, an accessed region 44 (as shown in FIG. 10) may be added, wherein the accessed region 44 may be blank at the beginning. The accessed region 44 is used to record the positions that the robot 1 has passed by under the operation mode. In part of the embodiments, the accessed region 44 may be regarded as an affection range of the functional action executed by the robot 1 (such as a patrol range or a sterilization range, etc.). By analyzing the exploration map 4, the processing device 10 may know whether any position is not yet accessed or worked (i.e., a not-yet-accessed region for this time) by the robot 1. As shown in FIG. 9, the goal map 5 may include a 2D obstacle region 50, an accessible region 52, and a 3D obstacle region 53.

In one embodiment, the 2D obstacle region 50 of the goal map 5 may be directly decided in accordance with the 2D obstacle regions 40 of the exploration map 4. In another embodiment, the processing device 10 may expand the 2D obstacle region 40 of the exploration map 4 to generate the 2D obstacle region 50 of the goal map 5.

In the present disclosure, the robot 1 moves based on the accessible region 52 of the goal map 5. The position and size of the 2D obstacle detected by the 2D detecting device 11 may have an error, the processing device 10 may expand the 2D obstacle region 40 of the exploration map 4 (e.g., outwardly increase the range covered by the 2D obstacle region 40), so as to generate the 2D obstacle region 50 (also called as an expanded 2D obstacle region 50) that is slightly greater than the 2D obstacle region 40. Also, the processing device 10 may use the expanded 2D obstacle region 50 to update the accessible region 52 of the goal map 5. Therefore, when moving based on the goal map 5, the robot 1 may be prevented from colliding with the 2D obstacles in the environment even if the 2D detecting process performed by the 2D detecting device 11 of the robot 1 has an error in detecting the 2D obstacle.

A 3D obstacle region 53 is used to indicate the position and the range of the 3D obstacle(s), and the 3D obstacle region 53 may be updated every time when a 3D obstacle is detected.

In the embodiment, the accessible region 52 of the goal map 5 may be the region generated by using the explored region 42 of the exploration map 4 to exclude the 2D obstacle region 40 (or the expanded 2D obstacle region 50 of the goal map 5) and the 3D obstacle region 53.

Please refer to FIG. 10 and FIG. 11, wherein FIG. 10 is a schematic diagram showing multiple layers of an exploration map of an embodiment according to the present disclosure and FIG. 11 is a schematic diagram showing multiple layers of a goal map of an embodiment according to the present disclosure.

In order to edit each region more easily, the exploration map 4 and the goal map 5 of the present disclosure may include multiple layers in some embodiments. For example, each layer indicates one or more than one of the regions. Therefore, by stacking multiple layers, the present disclosure may analyze and process the map data more quickly.

For an instance, the exploration map 4 may include four layers, each of the four layers respectively records the 2D obstacle region 40, the explored region 42, the accessed region 44 (also called as a worked region, wherein the accessed region 44 equals the worked region in some embodiments), and a moving track 43 of the robot 1.

The goal map 5 may include three layers, each of the three layers respectively records the expanded 2D obstacle region 50, the accessible region 52, and the 3D obstacle region 53.

In part of the embodiments, the goal map 5 further includes a layer indicating the worked region 54. Also, in part of the embodiments, the layer indicating the worked region 54 may be arranged in the exploration map 4.

In some embodiments, the accessed region 44 and the worked region 54 may be same or different. In the embodiments that the accessed region 44 and the worked region 54 are the same, the layer indicating the worked region 54 may be arranged in the exploration map 4, otherwise the layer indicating the accessed region 44 may be directly used by the exploration map 4 without arranging the layer for the worked region 54.

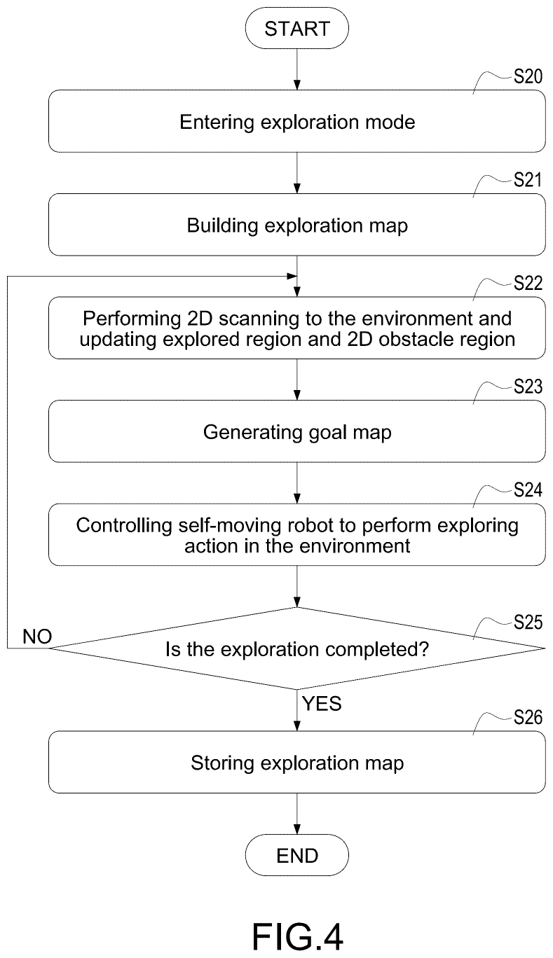

Please refer to FIG. 3 and FIG. 4, wherein FIG. 4 is a flowchart of an exploration mode of an embodiment according to the present disclosure. The automatic determining method of the present disclosure further includes steps S20 to S26 used to generate the exploration map 140 through automatic exploration.

Step S20: The processing device 10 switches to the exploration mode through the exploring module 310.

Step S21: The processing device 10 builds a blank exploration map 140 through the exploration map maintenance module 310 or updates and stores an exploration map 140 that is already built.

Step S22: The processing device 10 uses the 2D detecting device 11 through the 2D detection control module 300 to perform 2D scanning to the environment to obtain the position and the range of the 2D obstacle, and updates the explored region of the exploration map 140 through the exploration map maintenance module 308 based on the current position of the robot 1. Therefore, the un-explored region of the exploration map 140 may be reduced and the 2D obstacle region may be updated.

Step S23: The processing 10 performs 2D obstacle setting process based on the current exploration map 140 to generate the goal map 141.

Step S24: The processing device 10 controls, through the moving control module 302, the robot 1 to move based on the goal map 141 to perform the exploring action in the environment.

In one embodiment, the exploring action includes randomly moving in the environment or toward a default direction to build an initial explored region, and then moving toward un-explored region to perform exploring until all the regions are completely explored.

Step S25: The processing device 10 determines whether the exploration for this time is completed through the exploring module 310. For example, the processing device 10 determines whether the exploration map 140 still includes an un-explored region that is accessible by the robot 1, or whether receiving a stopping command, etc. If the exploration for this time is not yet completed, the processing device 10 executes the steps S22 to S23 again to update the exploration map 140 and the goal map 141.

Step S26: After the exploration for this time is completed, the processing device 10 operates the driving device 13 through the moving control module 302 to move the robot 1 to a preset standby position (such as the position of the charging station), and stores the latest exploration map 140 to the storage 14 through the recording module 306.

Therefore, the present disclosure may automatically generate the exploration map 140 for the environment.

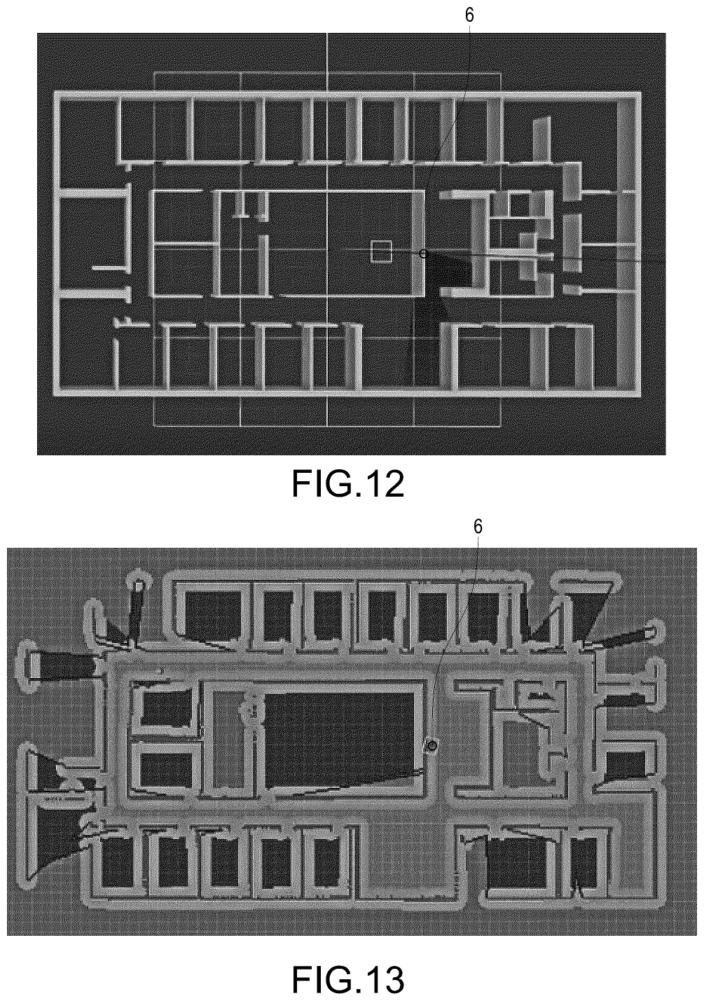

Please refer to FIG. 12 and FIG. 13, wherein FIG. 12 is an environment planimetric map of an embodiment according to the present disclosure and FIG. 13 is a schematic diagram of an exploration map built based on the environment of FIG. 12.

In the present embodiment, when exploring in the environment, the robot 1 performs 2D scanning to the environment (as shown in FIG. 12) and generates a corresponding exploration map (as shown in FIG. 13). It should be mentioned that, when exploring, the robot 6 may not only generate the corresponding exploration map based on a 2D scanning result of the 2D scanning, but also analyze the 2D obstacle region being detected in real-time based on the 2D scanning result (e.g., to analyze the width of the passage). Besides, the robot 6 may be restricted, after analyzing, to move toward a region that matches an inappropriate exploring condition. The inappropriate exploring condition may be, for example but not limited to, a passage having the width that is smaller than, equal to, or slightly greater than the size of the robot 6. Therefore, the robot 6 of the present disclosure may not enter a narrow space when exploring the environment, so that the robot 6 may be prevented from being trapped due to a narrow passage.

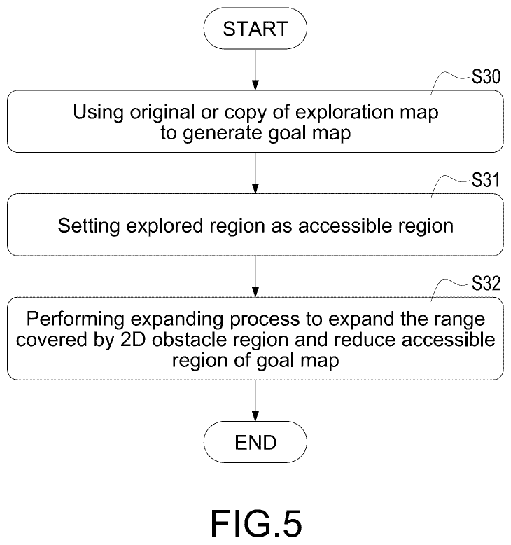

Please refer to FIG. 3 and FIG. 5, wherein FIG. 5 is a flowchart of a 2D obstacle setting process of an embodiment according to the present disclosure. In this embodiment, the aforementioned step S11 of the automatic determining method may further include steps S30-S32 with respect to automatically generating the goal map 141.

Step S30: The processing device 10 generates the goal map 141 through the goal map maintenance module 309. In one embodiment, the processing device 10 may use an original of the exploration map 140 to be the goal map 141. In another embodiment, the processing device 10 obtains a copy of the exploration map 140 to be the goal map 141, but not limited thereto.

Step S31: The processing device 10 directly sets the explored region of the exploration map 140 (i.e., the positions that the robot has accessed under the exploration mode) as the accessible region of the goal map 141 through the goal map maintenance module 309.

In one embodiment, the accessible region may be marked through breadth-first search (BFS) algorithm.

In another embodiment, regions out of the 2D obstacle region 40 of the exploration map 4 as shown in FIG. 8 may be set as the accessible region.

Step S32: The processing device 10 performs an expanding process to the 2D obstacle region of the exploration map 140 through the goal map maintenance module 309, so as to expand the range covered by the 2D obstacle region and generate an expanded 2D obstacle region of the goal map 141. As a result, the accessible region of the goal map 141 is reduced accordingly.

As mentioned above, the position and size of the 2D obstacles detected by the 2D detecting device 11 may have error, so that the processing device 10 performs the expanding process in the step S32 to generate the expanded 2D obstacle region of the goal map 141. Due to the error of the 2D detecting device 11, the robot 1 may have the risk of colliding with the 2D obstacles in the environment while moving based on the goal map 141; however, the risk may be reduced through performing the expanding process and generating the expanded 2D obstacle region of the goal map 141. In one embodiment, the expanding process is to expand the 2D obstacle region outwardly from the center of the 2D obstacle region of the exploration map 140 for a range about one-half to one-third of the width of the 2D obstacle region, but not limited thereto. Therefore, the present disclosure may generate the goal map 141 automatically and reduce the ratio of the robot in colliding with the 2D obstacles. Also, the method of the present disclosure executes same process to the 3D obstacles in the environment.

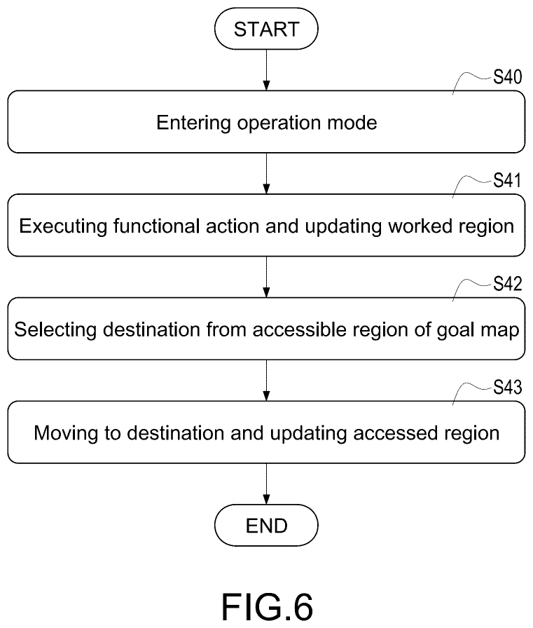

Please refer to FIG. 1 and FIG. 6, wherein FIG. 6 is a flowchart of an operation mode of an embodiment according to the present disclosure. In this embodiment, the aforementioned steps S10 to S16 of the automatic determining method may further include steps S40-S43 with respect to automatically updating the goal map 141.

Step S40: The processing device 10 switches to the operation mode through the operating module 311.

Step S41: The processing device 10 controls the function device 15 to execute the functional action, and the processing device 10 updates the worked region of the goal map 141 through the goal map maintenance module 309.

In one embodiment, if the function device 15 is used for patrol and monitoring, then the function device 15 may include an image capturing device. The processing device 10 may control the image capturing device to capture an image of the current environment, detect abnormal status of the captured image (e.g., movement detection or human detection), and send an alarm to the external computer (such as a computer used by the supervisor) through the communication device 16 if any abnormal status is detected.

In one embodiment, if the function device 15 is used for sterilization, then the function device 15 may include a sterilizing device. The processing device 10 may activate the sterilizing device to execute the sterilizing action to the current environment.

Step S42: The processing device 10 selects a reachable destination from the accessible region of the goal map 141 through the operating module 311.

In one embodiment, the processing device 10 may determine whether any position in the accessible region is not yet accessed for this time through the operating module 311 (i.e., determining the position of a not-yet-accessed region), and select the not-yet-accessed position (if exists) as the destination. Otherwise, the processing device 10 selects a standby position as the destination if every position in the accessible region is accessed.

Step S43: The processing device 10 controls the driving device 13 through the moving control module 302 to move the robot 1 to the destination, and the processing device 10 continuously updates the accessed region of the exploration map 140 (and/or the worked region of the goal map 141) through the exploration map maintenance module 308 during the robot 1 moves.

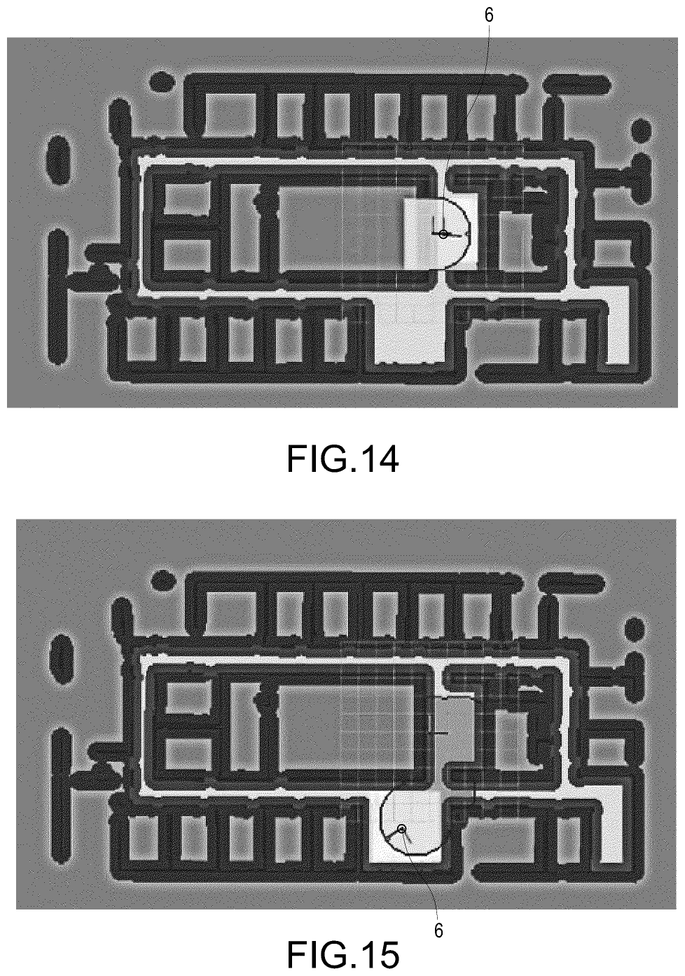

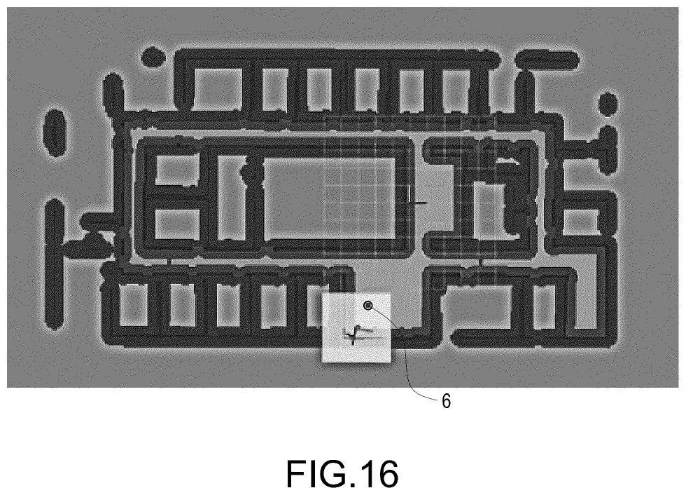

Please refer to FIG. 12 to FIG. 16, wherein FIG. 14 is a schematic diagram of a goal map built based on the environment of FIG. 12, FIG. 15 is a schematic diagram of performing an operation under the environment of FIG. 12, and FIG. 16 is a schematic diagram of completing the operation under the environment of FIG. 12.

The robot 6 may perform the expanding process to the exploration map (as shown in FIG. 13) to generate the goal map (as shown in FIG. 14). Also, the robot 6 may update the mark of the worked region (as shown in FIG. 15) in the map along with its operating range until all the regions are completely operated by the robot 6 (as shown in FIG. 16). In particular, the expanding process is to expand the 2D obstacle region(s) of the exploration map 140, so as to generate the 2D obstacle region(s) of the goal map 141.

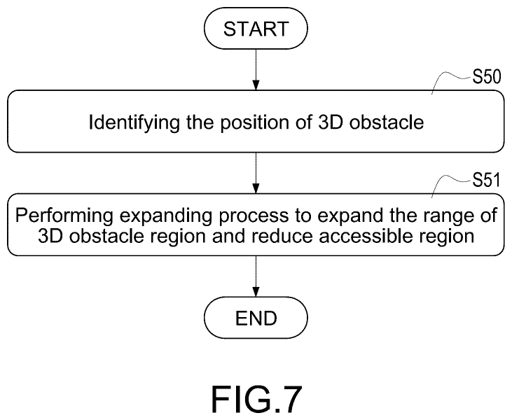

Please refer to FIG. 3 and FIG. 7, wherein FIG. 7 is a flowchart of a 3D obstacle setting process of an embodiment according to the present disclosure. In this embodiment, the aforementioned step S14 of the automatic determining method may further include steps S50-S51 with respect to automatically performing the 3D obstacle setting process.

Step S50: When the 3D avoidance device 12 detects a 3D obstacle, the processing device 10 identifies the position of the 3D obstacle through the 3D avoidance control module 301.

Step S51: The processing device 10 performs the expanding process to the position of the 3D obstacle in the goal map 141 through the goal map maintenance module 309 to generate an expanded 3D obstacle region and reduce the accessible region.

Similar to the 2D detecting device 11, the position and size of the 3D obstacle detected by the 3D avoidance device 12 may have an error. Therefore, the processing device 10 may perform the expanding process in the step S51 to generate the expanded 3D obstacle region, so as to reduce the risk of the robot 1 in colliding with the 3D obstacle in the environment due to the error of 3D detecting while the robot 1 moves.

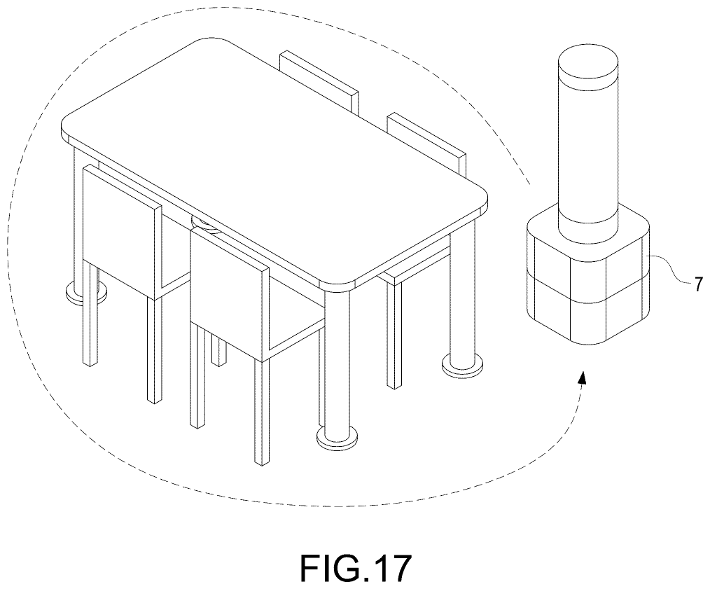

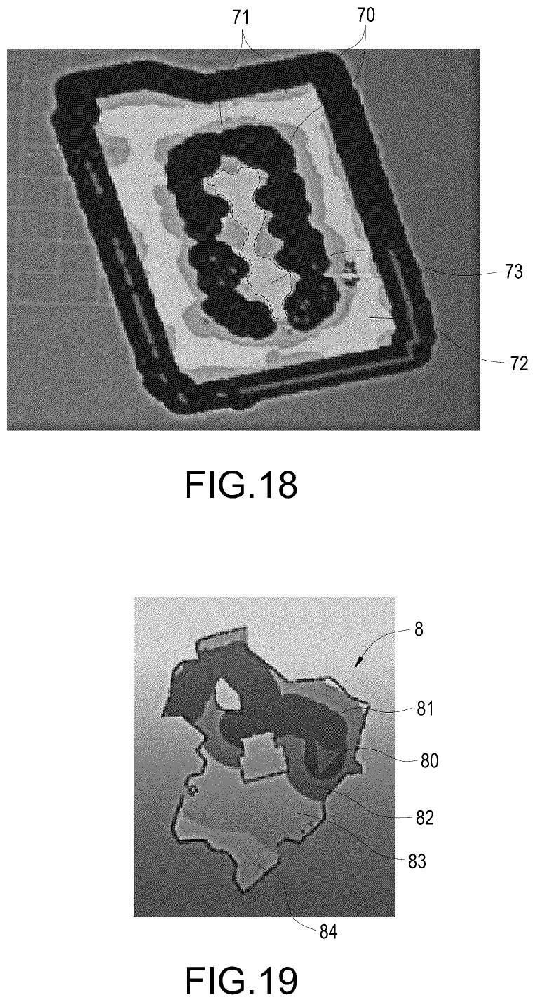

Please refer to FIG. 17 and FIG. 18, wherein FIG. 17 is a schematic diagram showing an environment of an embodiment according to the present disclosure and FIG. 18 is a schematic diagram showing a goal map built based on FIG. 17.

In the embodiment of FIG. 17, a robot 7 is a robot with a disinfection lamp, and the robot 7 operates in an environment having one dining table and four chairs.

If the robot 7 only uses the 2D detecting device 11 to perform obstacle detection, the 2D detecting device 11 can only detect table legs of the dining table and chair legs of the chairs (i.e., 2D obstacles) because the 2D detecting device 11 is provided aiming at low-height obstacles and incapable of detecting the desktop of the dining table and the surfaces of the chairs (i.e., 3D obstacles) which are located higher than the 2D obstacles. In such scenario, the robot 7 may mistake the space between the table legs and the chair legs as the accessible region; therefore, the robot 7 may try to move into the space and collie with the desktop and the chair surfaces.

In sum, as shown in FIG. 17, the goal map of the present disclosure prevents the robot 7 from collision or entering an inappropriate space through the expanded 2D obstacle region 70. Also, when the 3D avoidance device 12 detects a higher 3D obstacle that is located at a higher place, it may set the 3D obstacle region 71 in real-time to prevent the robot 7 from collision or entering the 3D obstacle region 71 that has the 3D obstacle being detected.

By setting the expanded 2D obstacle region 70 and the 3D obstacle region 71, an accessible region 72 may be decided, and an unreachable region 73 may also be decided.

In one embodiment, if a task needs to be done at a certain position corresponding to the unreachable region 73, the robot 7 may select a reachable position within the accessible region 72 that is most close to the certain position, and then move to this reachable position and try to carry out the task aimed at the certain position. Please refer to FIG. 19, which is a schematic diagram showing a worked region of an embodiment according to the present disclosure. In the embodiment, the worked region may be made with different marks respectively corresponding to different degrees of effect in accordance with the real effect carried out by the functional actions being executed.

Take sterilization for an example, within the worked region (e.g., layer 8), a track 81 that a robot 8 directly passed by is given a mark of a first degree (a highest degree, such as 100% sterilized), a first worked region 82 having a first default distance (such as 2 m) with the track 81 is given a mark of a second degree (such as 70% sterilized), a second worked region 83 having a second default distance with the track 81 (further than the first default distance, such as 2 m-4 m) is given a mark of a third degree (such as 40% sterilized), and other regions (such as an unworked region 84) is given a mark of a fourth degree (a lowest degree, such as 0% sterilized).

By way of the aforementioned marking approach, the present disclosure enables the user and the robot to easily understand the status and range covered by the effect of each functional action, so that the functional action may be executed again to compensate the one or more regions being treated with unsatisfied effect.

As the skilled person will appreciate, various changes and modifications can be made to the described embodiment. It is intended to include all such variations, modifications and equivalents which fall within the scope of the present invention, as defined in the accompanying claims.

What is claimed is:

1. A method of automatically determining an accessible region, being applied by a self-moving robot having a 2D detecting device and a 3D avoidance device, comprising:
a) obtaining an exploration map;
b) performing a 2D obstacle setting process in accordance with the exploration map to generate a goal map, wherein the goal map is marked with an accessible region that excludes a 2D obstacle region;
c) before a moving procedure, sensing a 3D obstacle through the 3D avoidance device, performing a 3D obstacle setting process to the goal map to set a 3D obstacle region corresponding to the 3D obstacle and update the accessible region to exclude the 3D obstacle region, and controlling the self-moving robot to perform an avoidance action; and
d) controlling the self-moving robot to move within the accessible region of the goal map.

2. The method in claim 1, wherein the step a) comprises receiving the exploration map through a communication device from an external computer or reading the exploration map from a storage;
wherein, the exploration map is configured to indicate a planimetric map of an environment and optionally indicate a moving track of the self-moving robot, and the goal map is configured to indicate the accessible region that prevents the self-moving robot from colliding with obstacles.

3. The method in claim 1, further comprising following steps before the step a):
e1) under an exploration mode, controlling the self-moving robot to perform an exploring action to an environment, wherein the exploring action comprises moving toward an un-explored region; and
e2) during the exploring action, using the 2D detecting device through a 2D detecting control module of the self-moving robot to perform a 2D scanning to the environment as the self-moving robot passes by to obtain position and range of a 2D obstacle, generating or updating the 2D obstacle region of the exploration map based on a current position of the self-moving robot, and creating an explored region in accordance with a region that the self-moving robot passed by under the exploration mode to generate or update the exploration map, wherein the exploration map is a planimetric map generated based on the 2D scanning performed by the 2D detecting device to indicate the environment.

4. The method in claim 3, further comprising following steps before the step a):
f1) during the exploring action, updating the explored region based on the current position of the self-moving robot to reduce the un-explored region; and
f2) after the exploring action, controlling the self-moving robot to move to a standby position and storing the exploration map.

5. The method in claim 3, wherein when executing the exploring action, the self-moving robot analyzes the 2D obstacle region in real-time and is restricted from moving toward a region that matches an inappropriate exploring condition, wherein the inappropriate exploring condition at least comprises a passage having a width that is smaller than, equal to, or slightly greater than a size of the self-moving robot.

6. The method in claim 1, wherein the 2D obstacle setting process comprises:
g1) regarding a position and a range of a 2D obstacle detected by the 2D detecting device under an exploration mode as the 2D obstacle region of the exploration map;
g2) using an original or a copy of the exploration map as the goal map, wherein a region that the self-moving robot passed by under the exploration mode is regarded as an explored region and the explored region is set as the accessible region.

7. The method in claim 6, wherein the 2D obstacle setting process further comprises:
g3) performing an expanding process to the 2D obstacle region to expand the 2D obstacle region of the goal map to reduce the accessible region of the goal map.

8. The method in claim 1, wherein the step d) comprises:
d1) under an operation mode, executing a functional action through a function device of the self-moving robot and updating a worked region of the goal map accordingly;
d2) selecting a destination within the accessible region of the goal map; and
d3) controlling the self-moving robot to move to the destination and updating an accessed region during the self-moving robot moves.

9. The method in claim 8, wherein the step d2) further comprises:
d21) when one position in the accessible region is not yet explored, selecting the position as the destination; and when every position in the accessible region is explored, selecting a standby position as the destination.

10. The method in claim 8, wherein the step d1) comprises at least one of the following steps:
d11) capturing an image of the environment through an image capturing device, executing an abnormal detection to the image being captured, and sending out an alarm to an external computer through a communication device when any abnormal status is detected; and
d12) activating a sterilizing device to perform a sterilizing action to the environment.

11. The method in claim 8, wherein when the self-moving robot moves, one of the worked regions along a track that the self-moving robot passed by is given a mark of a first degree, one of the worked regions having a first default distance with the track is given a mark of a second degree, one of the worked regions having a second default distance further than the first default distance with the track is given a mark of a third degree, and an unworked region is given a mark of a fourth degree.

12. The method in claim 1, wherein the 3D obstacle setting process comprises:
h1) performing an expanding process to a position of the 3D obstacle to generate an expanded 3D obstacle region and reduce the accessible region;
wherein, the avoidance action comprises stopping moving of the self-moving robot, re-computing a next moving target position that avoids the 3D obstacle in the accessible region and controlling the self-moving robot to move to the next moving target position, or moving the self-moving robot toward a direction away from the 3D obstacle.

13. The method in claim 1, wherein the goal map and the exploration map comprise multiple layers, and the multiple layers respectively record the 2D obstacle region, the 3D obstacle region, the accessible region, a worked region, an explored region, an accessed region, and a moving track.

14. The method in claim 1, wherein the self-moving robot is configured to continuously locate a current position to generate a consecutive position information while moving, form a moving track of the self-moving robot in the environment based on the consecutive position information, and record the moving track in the exploration map.

15. A self-moving robot of automatically determining an accessible region, comprising:
a driving device, used to move the self-moving robot;
a 2D detecting device, used to perform a 2D scanning to an environment;
a 3D avoidance device, used to detect a 3D obstacle in the environment;
a storage, used to store an exploration map;
a processing device, electrically connected with the driving device, the 2D detecting device, the 3D avoidance device, and the storage, configured to perform a 2D obstacle setting process based on the exploration map to generate a goal map, wherein the goal map is marked with an accessible region excluding a 2D obstacle region;
wherein, the processing device is configured to control the self-moving robot to move within the accessible region;
wherein, the processing device is configured to, before a moving procedure, detect the 3D obstacle and perform a 3D obstacle setting process to the goal map to set a 3D obstacle region corresponding to the 3D obstacle being detected and update the accessible region to exclude the 3D obstacle region, and control the self-moving robot to perform an avoidance action.

16. The self-moving robot in claim 15, wherein the 2D detecting device comprises a laser ranging sensor, a LiDAR, or a 2D radar, the 3D avoidance device comprises an image capturing device, a depth camera, or an ultrasonic sensor;
wherein, the processing device comprises:
an exploring module, being configured to control the self-moving robot to perform an exploring action to the environment under an exploration mode, and control the self-moving robot to move to a standby position after the exploring action, wherein the exploring action comprises moving toward an unexplored region; and
an exploration map maintenance module, being configured to perform a 2D scanning to the environment through the 2D detecting device to obtain a position and a range of a 2D obstacle, update the 2D obstacle region of the exploration map based on a current position of the self-moving robot, and update the explored region to reduce the unexplored region based on the current position of the self-moving robot.

17. The self-moving robot in claim 15, wherein the processing device comprises:
a 3D avoidance control module, being configured to identify a position of the 3D obstacle; and
a goal map maintenance module, being configured to use an original or a copy of the exploration map to be the goal map, set the explored region as the accessible region, perform an expanding process to the 2D obstacle region to expand the 2D obstacle region of the goal map and reduce the accessible region, and perform the expanding process to a position of the 3D obstacle to generate an expanded 3D obstacle region and reduce the accessible region;
wherein, the processing device is configured to perform the avoidance action to stop moving of the self-moving robot, re-compute a next moving target position in the accessible region that avoids the 3D obstacle and control the self-moving robot to move to the next moving target position, or move the self-moving robot toward a direction away from the 3D obstacle.

18. The self-moving robot in claim 15, further comprising a function device electrically connected with the processing device, the function device is configured to execute a functional action, and the processing device comprises:
a moving control module, being configured to, under an operation mode, select a destination from the accessible region of the goal map and control the self-moving robot to move to the destination;
an exploration map maintenance module, being configured to update an accessed region of the exploration map based on a current position of the self-moving robot; and
a goal map maintenance module, being configured to update a worked region of the goal map based on a position of executing the functional action;
wherein, the exploration map is configured to indicate a planimetric map of the environment and optionally indicate a moving track of the self-moving robot, and the goal map is configured to indicate the accessible region that prevents the self-moving robot from colliding with obstacles.

19. The self-moving robot in claim 15, wherein the goal map and the exploration map comprise multiple layers, and the multiple layers are configured to respectively record the 2D obstacle region, the 3D obstacle region, the accessible region, a worked region, an explored region, an accessed region, and a moving track.

20. The self-moving robot in claim 15, further comprising a function device electrically connected with the processing device, and the function device comprises an image capturing device or a sterilizing device;
wherein the processing device comprises a function control module being configured to execute a monitoring action or a sterilizing action, the monitoring action comprises capturing an image of the environment through the image capturing device, executing an abnormal detection to the image being captured, and sending out an alarm to an external computer through a communication device when any abnormal status is detected, and the sterilizing action comprises activating the sterilizing device to perform sterilization to the environment.
